(19) United States
(12) Patent Application Publication
(10) Pub. No.: US 2006/0050924 A1
(43) Pub. Date: Mar. 9, 2006

(54) Angled cone of loudspeaker

(76) Inventor: Hiroshi Ohara, Tao-Yuan Hsien (TW)

Correspondence Address: SUPREME PATENT SERVICES, P.O. BOX 2339, SARATOGA, CA, 95070-0339, US

(21) Appl. No.: 10/934,900

(22) Filed: Sep. 3, 2004

(51) Int. Cl. H04R 1/00; H04R 9/06

(52) U.S. Cl. 381/423; 381/424; 381/432

(57) ABSTRACT

An angled cone of a loudspeaker is formed integrally, and has an expanded end forming an outer verge extending outwardly to form a convex suspension rim. The surface of the convex suspension rim is overlaid with an elastic layer so that a better vibration form and a preferred tone quality could be outputted, and thereby, it is possible to alleviate the elastic fatigue and spoilage of the cone and control damping and value Q of the loudspeaker.

### BACKGROUND OF THE INVENTION

1. Field of the Invention

The present invention relates to the field of loudspeaker, and in particular to a paper cone of the loudspeakers.

2. The Prior Arts

A typical dynamic loudspeaker is usually comprised of a motive power system, a paper cone, and a suspension system. The motive power system further comprises a magnet, an electrode piece, an upper iron, gap, and a voice coil. The paper cone, which is a diaphragm for displacing air, is generally formed as a conic or semi-spherical acoustic bowl. The suspension system, which is comprised of a damper and a suspension rim, is provided for damping the diaphragm to move in a specified direction.

The dynamic loudspeaker operates in the way that an electromagnetic field is generated in a direction perpendicular to the magnetic field induced by a permanent magnet of the loudspeaker when a current flows through the voice coil of the loudspeaker such that a movable coil is activated to move within a gap (a clearance between the voice coil and the magnet) to enable the diaphragm attached on the voice coil to vibrate up and down and generate sound as a transducer.

A conventional paper cone of loudspeaker is commonly formed of cloth, paper, rubber, or even metal depending on tone range and quality required, and provided with a central hole for mounting a voice coil. Also, the internal loss and output vibration of the paper cone can be controlled by proper selection of rigidity, thickness, and strength, of the material that makes the cone. In addition, the damp and value Q might be controlled through the connection of the paper cone with a suspension rim of speaker frame.

### SUMMARY OF THE INVENTION

Since a paper cone of a conventional loudspeaker is generally peripherally fixed to a speaker frame through adhering a suspension rim, a poor adhering job is liable to deteriorate the precision and symmetry of the paper cone such that torsion is created to affect the tone quality of the loudspeaker accordingly. Besides, the juncture between the paper cone and the suspension rim may break or fracture easily due to the high frequency vibration of the paper cone.

To overcome the above-mentioned defects, the present invention proposes an integrally formed paper cone with a better symmetry, whose outer verge is expanded to form a suspension rim overlaid with an elastic layer such that damping and value Q of the loudspeaker can be controlled.

The merits of the present invention may be summarized as follows: (1) Better tone quality and vibration form is obtained due to the integrally molded paper cone. (2) Elastic fatigue of the suspension rim is alleviated. (3) The damping and value Q of a loudspeaker can be controlled easily by overlaying some layers on the surface of the suspension rim surrounding the paper cone.

For more detailed information regarding advantages or features of the present invention, at least one example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 is an exploded view of a paper cone constructed in accordance with the present invention; and

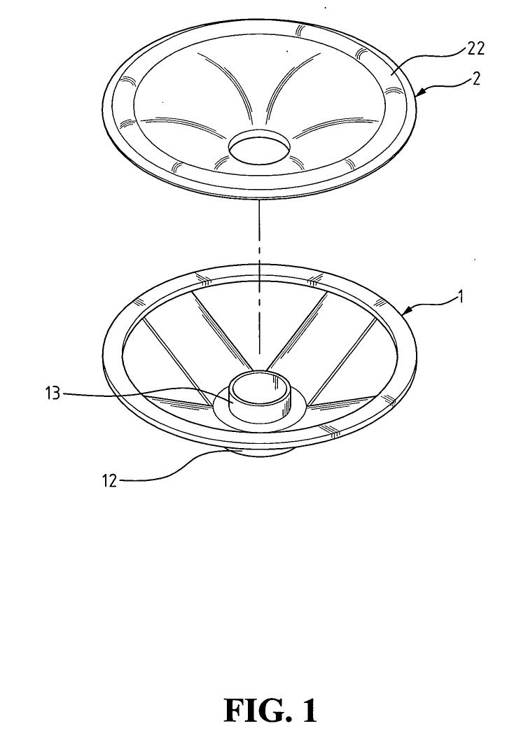

FIG. 2 is a cross-sectional view of the paper cone of the present invention.

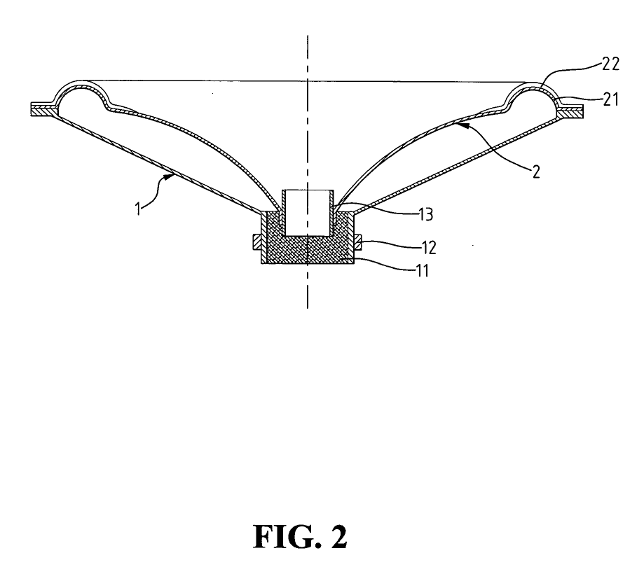

### DETAILED DESCRIPTION OF THE PREFERRED EMBODIMENT

With reference to the drawings, a paper cone constructed in accordance with the present invention is employed in a loudspeaker. The paper cone that is generally designated with reference numeral 2 is mounted to a pot-shaped frame 1 of the loudspeaker.

The frame 1 has a cylindrical bottom 11, which is surrounded by an annular permanent magnet 12 and extends upwardly to form a tubular voice coil 13.

The paper cone 2 is integrally formed of cloth, rubber, paper, or even combined with a metallic panel, and has an expanded outer end forming a suspension rim 21 overlaid with an elastic layer 22. A hole (not labeled) defined in a bottom end of the paper cone 2 receives and retains the voice coil 13. The paper cone 2 is fixed to an inner circumference at a top end of the frame 1 by means of the suspension rim 21. Moreover, the elastic layer 22 is made of a material having desired elastic property, such as rubber.

Both the upper and the lower surfaces of the suspension rim 21 are overlaid with the elastic layer 22.

Alternatively, the paper cone 2 is formed by combining multiple layers together such that a buffer is created on the top end of the suspension rim 21 without overlaying any extra elastic layer 22 thereon.

Since the paper cone 2 can be made integrally by using composite materials, it allows for maintaining symmetry of the paper cone and the vibration form thereof even when the precision of measurements and/or attachment of the suspension rim 21 are below standards. Therefore, according to the present invention, a paper cone having rigidity, thickness, strength and the internal loss and value Q thereof that can be controlled easily is obtainable. Moreover, as the surface of the suspension rim 21 can be further overlaid with different layers of paper, foam rubber, cloth, rubber, etc., the damping and value Q of a loudspeaker can be controlled, too.

Because the paper cone 2 of the present invention is made integrally, the suspension rim 21 is somewhat reinforced against the elastic fatigue or spoilage incurred by the repeated vibration.

In the above described, at least one preferred embodiment has been described in detail with reference to the drawings annexed, and it is apparent that numerous changes or modifications may be made without departing from the true spirit and scope thereof, as set forth in the claims below.

1. An angled cone of a loudspeaker, comprising an integrally formed conic body having a convex suspension rim, said convex suspension rim including a convex section integrally formed and expanded outwardly near an outmost flat rim of said conic body.

2. The angled cone of a loudspeaker as claimed in claim 1, wherein a surface of the convex suspension rim is overlaid with an elastic layer.

3. The angled cone of a loudspeaker as claimed in claim 2, wherein the convex suspension rim has upper and lower suffices overlaid with the elastic layer.

4. The angled cone of a loudspeaker as claimed in claim 1, wherein the conic body is formed by combining multiple layers of different materials together.
